(19) United States
(12) Patent Application Publication
(10) Pub. No.: US 2002/0138823 A1
(43) Pub. Date: Sep. 26, 2002

(54) Method and device for transmitting simulation models between simulators

(76) Inventors: Notker Amann, Friedrichshafen (DE); Carsten Thomas, Bremen (DE); Ines Fey, Berlin (DE); Matthias Hoffman, Berlin (DE); Gisela John, Berlin (DE)

Correspondence Address: VENABLE, BAETJER, HOWARD AND CIVILETTI, LLP, P.O. BOX 34385, WASHINGTON, DC, 20043-9998, US

(21) Appl. No.: 09/890,792

(22) PCT Filed: Jan. 28, 2001
(86) PCT No.: PCT/EP00/00657

(30) Foreign Application Priority Data
Feb. 5, 1999 (DE) 199 06 177.7

(51) Int. Cl. G06F 19/00

(52) U.S. Cl. 717/140

(57) ABSTRACT

The invention relates to a device and a method for transmitting simulation models (11, 18) between simulators (10, 17), the device having a first input/output element (22), to which the simulation model (11) is transmitted from the first simulator (11), having a processing unit (24), which, after the simulation model (11) has been transmitted, separates the model into individual operators (12) and stores the operator association (16), wherein the operators (12) that can be integrated, as external operators (19) and with semantic equivalence, by the second simulator (17) with the aid of the operator association (16) can be compiled into an operator library (12 [sic]), the device further having a second input/output element (23), which outputs the operator library and additionally provides the operator association (16).

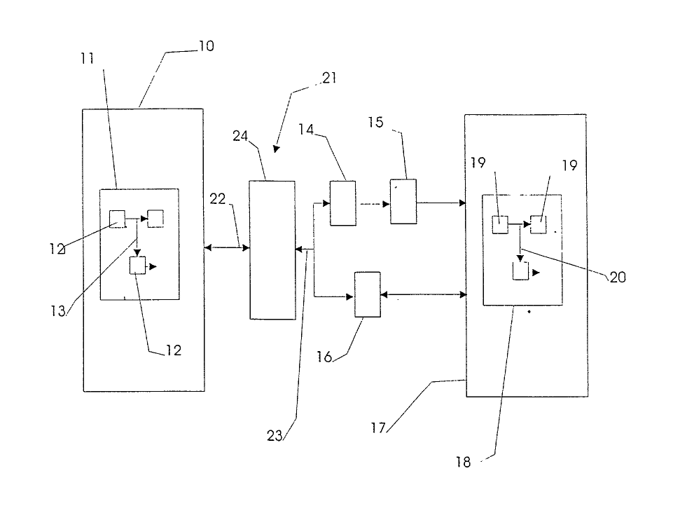

The invention relates to a device and a method for transmitting simulation models between at least two simulators, with which it is possible to transmit the simulation model from the first simulator to a processing unit by way of a first input/output element.

The field of simulation encompasses numerous types of simulators that permit the graphic, component-oriented specification of systems as a dynamic signal-flow simulation model, as well as the simulation of the dynamic behavior of these simulation models. Examples of these simulators include Simulink, SystemBuild, ControlH, Beacon and Scade. These simulators differ in their functioning and representation capabilities, with each system having its own advantages and shortcomings. For example, the system specification in one simulator may be particularly well-supported, whereas the simulation and analysis capabilities of another simulator may be more comprehensive.

A critical challenge that is frequently encountered in the use of these simulators is how to transmit simulation models that have been created with one simulator to another. This presents the opportunity of combining the advantageous features of various simulators. The transmission of models permits significant savings in terms of costs and time. Furthermore, the back-transfer of simulation models, that is, the use of a bi-directional translator between two simulators, is crucial for efficient operation.

The current technology used in the transmission of simulation models is based on two different approaches. The first method is the direct translation of the simulation model. Here, a description of a simulation model is created from the description of the model that was written for a simulator A; the description can be read by the other simulator B. In the translation process, each individual operator of the simulation model of the simulator A is replaced by a corresponding operator of the other simulator B.

This type of translation requires that, for each individual operator of the simulator A that was used in the simulation model to be translated, a semantically and syntactically equivalent operator must exist in the other simulator. Because this condition is not typically assured, the direct translation method is only possible in rare cases. Often, a sub-set of functions that are present in both simulators is defined, and only this set is translated.

Moreover, the operators often differ in their details, so while a basic transmission is possible, the dynamic behavior of the simulation model in one simulator is different in another simulator.

An example of this direct type of translation is the simulator currently being used for translating from SystemBuild into Scade, which was created by ISI and Verilog (“Codesign Method and Integrated Tools for Advanced Embedded System (COMITY)” (Project reference 23015). This is a project sponsored by the European Union under the heading “Esprit 4,” which is part of the fourth framework program of the European Union, sub-program: “Software Technologies Software Intensive Systems Engineering”).

The second transmission method is the communication between two simulators by means of a meta-description. This means that an export function of the simulators effects the creation of a description of the simulation model that can be read and written by both simulators. This meta-description specifies a description language that is then used to describe the actual information in a general manner.

The reading simulator first reads the meta-description, attempts to understand it, and then interprets the description based on its understanding of the meta-description. A problem associated with this procedure is that the interpretations of the writing simulator and the reading simulator can differ. Additionally, information can be lost, because the simulation models are more generally specified in the meta-description.

The semantic identity of a simulation model in the two simulators is not given, and a loss-free back-transfer is usually not possible. Parallels can be drawn here with human language translation, in which the original meaning is often altered by the process of translation into different languages. An example of this type of transmission is CDIF, a quasi-standard for exchanging information between simulation-modeling simulators and databases, as described by Johannes Ernst in “Data Interoperability between CACSD and CASE Tools using the CDIF.”

Another option exists for transmitting at least the dynamic behavior of a simulation model from one simulator to another. The starting point is a simulation model that was specified with a simulator. The source code for the entire simulation model is then generated by means of an automatic code generator of this simulator. The entire source code is incorporated as an external module into the other simulator. Consequently, all structural information is lost; the originally detailed simulation model becomes a single block. It is therefore impossible to process the model further in the second simulator.

The general code generation also causes information to be lost, so the simulation model predetermined as an external module represents an inadequately accurate description in the second simulator.

The publication by Campbell, S. L., et al., “A mixed symbolic-numeric software environment,” Proceedings of the 1996 IEEE international symposium on computer-aided control system design (CAT. No. 96TH8136), Proceedings of joint conference on control applications intelligent control and computer-aided control system design, Dearborn, Mich., USA, pp. 436-441, XP002138640, 1996, New York, N.Y., USA, IEEE, USA, ISBN: 0-7803-3032-3, describes a method in which symbolic objects are converted into numerical objects. Maple is used for the symbolic calculations, and Scilab is simulation model is transmitted from a first simulator; a processing unit, which, following the transmission of the simulation model, separates the model into individual operators and stores the operator association, and creates an operator library from the operators that can be integrated, as external operators and with semantic equivalence, by the second simulator with the aid of the operator association; and having a second input/output element that outputs the operator library and provides an additional operator association.

With these measures, a simulation model is created that can notably be translated in both directions without losing semantic information. It is therefore possible to execute a transfer that does not distinguish in which simulator the specification or simulation has taken place.

The simulation model is separated into base operators that are exported, in a universal, simulator-readable form, into an operator library. The exported operator library is preferably present in the form of compilable source codes.

The second input/output element can both export and import the operator association, so the processing unit can use the internal operators of the first simulator to create a simulation model that has been changed accordingly by the used for the numerical calculations. Maple and Scilab are handled separately, with an external tool effecting the conversion.

In Ansari, A., et al.: “Process modeller (PROMO)” Simulators international XIV. Proceedings of the 1997 simulation multiconference, simulators international XIV. Proceedings of the 1997 simulation multiconference, Atlanta, Ga., USA, Apr. 6-10, 1997, pp. 137-142, XP000886699 1997, San Diego, Calif., USA, SCS, USA, ISBN: 1-56555-121-4 a software is presented that provides an intuitive, graphic user interface that assures user-friendly handling. Here, model parameters and displays can be quickly set up, defined and manipulated. This software can be used, for example, to convert text-based models into graphic displays.

It is the object to provide a device and a method that permit the transmission of a simulation model between two different simulators, in which the information content and level of accuracy are intended to be maintained, the dynamic behavior is intended to remain unchanged, and it should be possible to effect further specification on the simulation model.

This object is accomplished by the features of the device claim 1 and the method claim 4, particularly by a device for transmitting simulation models between simulators, in which the simulation model can be transmitted from the first simulator to a processing unit by a first input/output element, and, in accordance with the invention, the processing unit can separate the model into individual base operators and store the operator association; the base operators can be exported as source codes into an operator library, and, after being compiled, the base operators that can be integrated, as external operators and with semantic equivalence, by the second simulator with the aid of the operator association can be combined in an operator library; the device further having a second input/output element that can output the operator library and additionally provide the operator association.

With these measures, a simulation model is created that can notably be translated in both directions without losing semantic information. It is therefore possible to execute a transfer that does not distinguish in which simulator the specification or simulation has taken place.

The simulation model is separated into base operators that are exported, in a universal, simulator-readable form, into an operator library. The exported operator library is preferably present in the form of compilable source codes.

The second input/output element can both export and import the operator association, so the processing unit can use the internal operators of the first simulator to create a simulation model that has been changed accordingly by the second simulator, and transmit the model back to the first simulator by way of the first input/output element.

The object is accomplished by the method for transmitting a simulation model between a first simulator and a second simulator, in which, according to the invention, the simulation model of the first simulator is separated into its operators, the operators are exported into an operator library such that they can be utilized by the second simulator, and, in addition to the operator library, an operator association that can be read and preferably altered by the first and second simulators, and forms the basis of the simulation model, is exported to the operator library.

The dependent claims disclose further advantageous measures. The invention is illustrated in the attached drawing and described in further detail below.

The single drawing FIGURE shows a schematic circuit diagram of two simulators that are connected to one another by a device for transmitting simulation models. The first simulation model is separated into components that are in turn stored in an operator library. The second simulator converts the simulation model into a new, semantically-equivalent model using the integratable operator library with the aid of the operator association.

The FIGURE schematically illustrates two simulators 10 and 17, on which simulation models 11 and 18 are running. The first simulation model comprises internal operators 12, which are provided by the first simulator 10. Association vectors 13 connect the operators 12 to one another, thereby determining the semantics of the simulation model 12 [sic].

A first input/output element 22 transmits the simulation model 11 to a device for transmitting simulation models 21. This device for transmitting simulation models 21 comprises a processing unit 24 and a second input/output element 23.

To prepare for the actual transmission, the processing unit 24 separates the first simulation model 11 of the first simulator 10 into its operators 12. The operators 12 are exported into an operator library 15 such that they can be used semantically correctly by the second simulator 17. This is typically effected by the generation of a universal source code for each operator 12 in the operator library 14. A compilation produces an integratable operator library 15.

The actual transmission is effected by the export of an operator association 16, which can be read and altered by the first simulator 10 and the second simulator 17. This alteration can produce new association vectors 20.

The two simulation models 11 and 18 comprise a series of base operators 12. All of these operators 12 are exported as source codes from a first simulation model 11, with the aid of the device for transmitting simulation models 21, into the operator library 14, then transferred into the external operator library 15 after being compiled. From there, they can be incorporated into the second simulation model 18 to be used for specifying the simulation model 18. This means that source codes from the first simulation model 11 are automatically generated in a programming language for the individual operators 12. This type of source code is provided with an external frame that permits the use of each operator as an external operator in the second simulation model 18.

The creation of the external operator library 15 from the internal operators 12 of the first simulation model 11 is a preparatory step. The external frame performs additional functions to permit the integration as external operators into the second simulation model 18, i.e., to correspond to the syntactic requirements of the second simulation model 18 for external operators.

In the second simulator 17, a simulation model 18 is specified solely with the use of the external operator library 15. This ensures that the second simulation model 18 can be transmitted to the first simulator 10.

A device for transmitting simulation models 21 can transmit the first simulation model 11 into the second simulation model 18, thereby creating an operator association 16 and an operator library 14, 15.

For specifying a model, therefore, a simulation model 11 can be created in normal operations in the first simulator 10; namely, the model is created from internal individual operators 12. It is also possible to create the second simulation model 18 with the second simulator 17 using only external operators 19.

A prerequisite for this method is that the second simulator 17 must permit the incorporation of external operators 19 from the external operator library 15 into the second simulation model 18. The entire second simulation model 18 consequently comprises external operators 19. Concealed behind each external operator 19 is an internal operator 12 of the first simulation model 11. Therefore, the same modeling as in the first simulation model 11 is possible in the second simulation model 18. Each operator 12 and 19 is equivalent in the two simulation models 11 and 18, respectively, because it is based on the first simulation model 11.

Equivalence means that the functioning capability of each operator 12 and 19 in the two simulation models 11 and 18 is identical. The operator exhibits the same behavior in both simulation models. The overall behavior of a model is therefore identical, because it represents the sum of the individual dynamics.

A simulation model 19 that was specified in the second simulator 18 can be transmitted to the first simulator 10 in that each external operator 19 is allocated the corresponding internal operator 12 of the first simulator. Based on the described procedure, the allocation is problem-free, because the second simulation model 18 only comprises external operators 19 for which a corresponding internal operator 12 exists. Consequently, it is possible to translate in both directions.

An exemplary embodiment is the coupling of Scade and Simulink. Scade, a code generator by Verilog, generates the source code from specifications of simulation models. A source code of this type can be used in safety-relevant applications, such as in the aircraft industry. Scade can only be used to a limited extent in inputting simulation models, and simulation itself.

Simulink, a simulator by Mathworks, can be used in numerous simulation applications. It offers a user-friendly simulation-model input and simulation of the dynamic behavior. It is, however, unsuitable for generating source codes for safety-relevant applications.

The method in accordance with the invention can couple the two simulators Scade and Simulink. For this purpose, source codes are generated for all of the operators provided by Scade. These source codes are expanded with corresponding routines, so they can be used as external operators in Simulink.

This procedure is performed individually for operators. The result is an operator library 15 with which models can be specified in Simulink. The specification is effected in the user-friendly Simulink environment, where the dynamic behavior of the model can be analyzed.

A simulation model for Scade must be constructed for generating source codes for safety-relevant applications. To this end, the model description is translated from Simulink to Scade. In the process, each operator is allocated the corresponding, original Scade operator. An unambiguous association exists between the operators 11 and 19 of the two models. The two models exhibit the same dynamic behavior, which in both cases is based on the code generated by Scade.

### CITED LITERATURE

[COMITY98] “Codesign Method and Integrated Tools for Advanced Embedded System [COMITY]” (project reference 23015). EU-supported project under the heading of “Esprit 4,” part of the fourth framework program of the EU. Sub-program: “Software Technologies—Software Intensive Systems Engineering.”

[Ernst86] Johannes Ernst, “Data Interoperability between CACSD and CASE tools Using the CDIF Family of Standards. Proc. Of 1986 IEEE Int. Symp. On Computer-Aided Control System Design, Dearborn, Mich., 1986.

[CD1F97] Internet Address: http://www.cdif.org/. Mailing address: CDIF, Electronic Industries Association, c/o Patti A. Rusher, Director, Electronic Information Group, 2500 Wilson Blvd., Arlington, Va. 22201, USA. Tel.: +1 (703) 907-7545. Fax: +1 (703) 907-7501.

1. A device (11 [sic]) for transmitting simulation models (11, 18) between simulators (10, 17), in which a first input/output element (22) can transmit the simulation model (11) from the first simulator (10) to a processing unit (24), characterized in that
the processing unit (24) can separate the simulation model (11) into individual base operators (12) and store the operator association (16);
the base operators (12) can be exported as source codes into an operator library (14);
after being compiled, the base operators (12) that can be integrated, as external operators (19) and with semantic equivalence, by the second simulator (17) with the aid of the operator association (16) can be combined in an operator library (15); and
a second input/output element (23) can output the operator library (14) and additionally provide the operator association (16).

2. The device according to claim 1, characterized by a second input/output element (23), which both exports and imports the operator association (16), wherein the processing unit (24) creates a simulation model (11) with internal operators (12) of the first simulator (10), the simulation model (11) having been altered correspondingly by a second simulator (17) and being suitable to be transmitted back to the first simulator (10) by way of the first input/output element (22).

3. The device according to claim 1 or 2, characterized in that it is an integrated component of one of the simulators (10, 17).

4. A method for transmitting a simulation model between a first and a second simulator, characterized in that
the simulation model of the first simulator is separated into its operators, and the operator association is stored;
the operators are exported into a first exported operator library and, after a compilation, are combined in a second, integratable operator library to form external operators whose semantics match those of the operators of the first simulator, such that they can be integrated, semantically correctly, by the second simulator; and
in addition to the operator library, the operator association is exported, which can be read by both the first and second simulators and forms the basis of the simulation model.

5. The method according to claim 4, characterized in that the exported operator library comprises source codes, and the integratable operator library comprises an object code, which the second simulator links as external operators.

6. The method according to claim 5, characterized in that the operator association represents the simulation model on the basis of the exported operators.
